(19) United States
(12) Patent Application Publication
(10) Pub. No.: US 2019/0108500 A1
(43) Pub. Date: Apr. 11, 2019

(54) DEVICES AND METHODS FOR CONFIGURING DATA TRANSFER REQUESTS

(71) Applicant: The Toronto-Dominion Bank, Toronto (CA)

(72) Inventors: Peter HORVATH, Toronto (CA); Eric Paul Jr. KAISER, Auburn, ME (US); Steven GERVAIS, Newmarket (CA); John Jong-Suk LEE, Toronto (CA); Arun Victor JAGGA, Toronto (CA)

(21) Appl. No.: 15/725,741

(22) Filed: Oct. 5, 2017

(51) Int. Cl. G06Q 20/10; H04L 12/58; H04L 29/12; G06Q 20/36; G06Q 50/00; G06Q 20/32

(52) U.S. Cl. CPC G06Q 20/10; H04L 51/20; H04L 51/32; G06Q 20/3223; G06Q 20/36; G06Q 50/01; G06Q 20/3224; H04L 61/1594

(57) ABSTRACT

A computer-implemented method for generating a data transfer request is disclosed. The method includes: receiving, via an input interface of an electronic device: an instruction to generate a request for a data transfer, and a selection of a contact for which the data transfer is destined; obtaining social media data associated with the selected contact, the social media data including data associated with one or more social networking accounts corresponding to the selected contact; determining a location associated with the selected contact based on analyzing location-related information for the selected contact from the obtained social media data; and sending, to a remote computer, a data transfer request, wherein a type of the data transfer request is determined based on the location associated with the selected contact.

### TECHNICAL FIELD

The present disclosure relates to data transfers and, more particularly, to configuring requests for data transfers.

### BACKGROUND

Electronic devices may be utilized to perform various types of data transfers. In some cases, dedicated applications may be provided that allow performance of data transfers. Such data transfer applications may support various data transfer methods.

When configuring a request for a data transfer using an electronic device, properties of the transfer that are specific to the intended recipient, such as a suitable type, format, and destination, may not be readily ascertained from the data that is available on the electronic device. As a consequence, the data transfer may be delayed or not made at all.

### BRIEF DESCRIPTION OF DRAWINGS

Reference will now be made, by way of example, to the accompanying drawings which show example embodiments of the present application and in which:

FIG. 1 is a schematic operation diagram illustrating an operating environment of an example embodiment;

FIG. 2 is a high-level operation diagram of an example electronic device;

FIG. 3 depicts a simplified software organization exemplary of the example electronic device of FIG. 2;

FIG. 4 depicts a simplified organization of software modules exemplary of an embodiment of a data transfer application;

FIG. 5 is a flowchart depicting example operations performed by a data transfer application;

FIG. 6 is a flowchart depicting example operations performed by a data transfer application; and

FIGS. 7A-7B illustrate user interfaces of a data transfer application in accordance with example embodiments.

Like reference numerals are used in the drawings to denote like elements and features.

### DETAILED DESCRIPTION OF EXAMPLE EMBODIMENTS

In one aspect, the present disclosure describes an electronic device including: an input interface; a communications module for communicating with one or more computer networks; a memory; and a processor coupled to the input interface, the communications module, and the memory, the processor being configured to: receive, via the input interface: an instruction to generate a request for a data transfer, and a selection of a contact for whom the data transfer is intended; obtain social media data associated with the selected contact, the social media data including data associated with one or more social networking accounts corresponding to the selected contact; determine a location associated with the selected contact based on analyzing location-related information for the selected contact from the obtained social media data; and send, to a remote computer using the communications module, a data transfer request, wherein a type of the data transfer request is determined based on the location associated with the selected contact.

In another aspect, the present disclosure describes a computer-implemented method including: receiving, via an input interface of an electronic device: an instruction to generate a request for a data transfer, and a selection of a contact for whom the data transfer is intended; obtaining social media data associated with the selected contact, the social media data including data associated with one or more social networking accounts corresponding to the selected contact; determining a location associated with the selected contact based on analyzing location-related information for the selected contact from the obtained social media data; and sending, to a remote computer, a data transfer request, wherein a type of the data transfer request is determined based on the location associated with the selected contact.

In another aspect, the present disclosure describes a non-transitory computer readable storage medium storing instructions which, when executed by a processor of an electronic device, cause the electronic device to: receive, via the input interface: an instruction to generate a request for a data transfer, and a selection of a contact for whom the data transfer is intended; obtain social media data associated with the selected contact, the social media data including data associated with one or more social networking accounts corresponding to the selected contact; determine a location associated with the selected contact based on analyzing a subset of the obtained social media data that contains location-related information for the selected contact; and send, to a remote computer using the communications module, a data transfer request, wherein a format of the data transfer request is determined based on the location associated with the selected contact.

Other example embodiments of the present disclosure will be apparent to those of ordinary skill in the art from a review of the following detailed descriptions in conjunction with the drawings.

As the use of social networking sites, such as Facebook™, Twitter™, LinkedIn™, etc. becomes increasingly prevalent, the amount of data that is available via these networks has increased dramatically. In many instances, more information about an entity (e.g. individuals, businesses, etc.) can be gleaned from the social media accounts of the entity than from traditional sources of information such as, for example, address book entries, advertisements, personal or promotional websites, etc. In particular, social media data for an entity may be updated frequently and dynamically/real-time based on the activities (e.g. sharing, commenting, etc.) of the entity on various social media platforms.

Furthermore, connecting with entities via social networks can often be more convenient and useful than connecting by more traditional means, such as exchanging phone numbers or emails. Indeed, if a connection is made with an entity via one or more social networks, there may be no need to expressly obtain other information about the entity, for example, to store on a user's mobile device or contact manager.

The present disclosure provides techniques for configuring requests for data transfers such as payments. More specifically, the methods described herein leverage data that is obtained from social network accounts/servers to determine a suitable type and/or destination for a requested data transfer. The social media data for a contact selected as a recipient of a data transfer is obtained, in order to determine a probable location associated with the contact. The determined location of the selected contact is, in turn, used to inform the type of data transfer that should be requested. In one example, data transfers may correspond to payments, or funds transfers, with data transfer methods corresponding to particular payment methods. Data transfers corresponding to payments may be performed using a data transfer application such as a payment or “mobile wallet” application. By leveraging social media data about the recipient of a payment, a suitable payment method may be determined based on information that is updated real-time or near real-time. This dynamic provisioning of data transfer requests may, for example, allow making urgent payments by suitable payment means, without lengthy delays. Furthermore, the option to select social media connections, and not just address book contacts, as recipients of data transfers increases the flexibility for a sender of the data: the sender is able to select from an extended list of possible recipients, without having to manually enter all of their information into the sender's device, and to format the data transfer request appropriately based on readily available social media data for the selected recipient contact.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

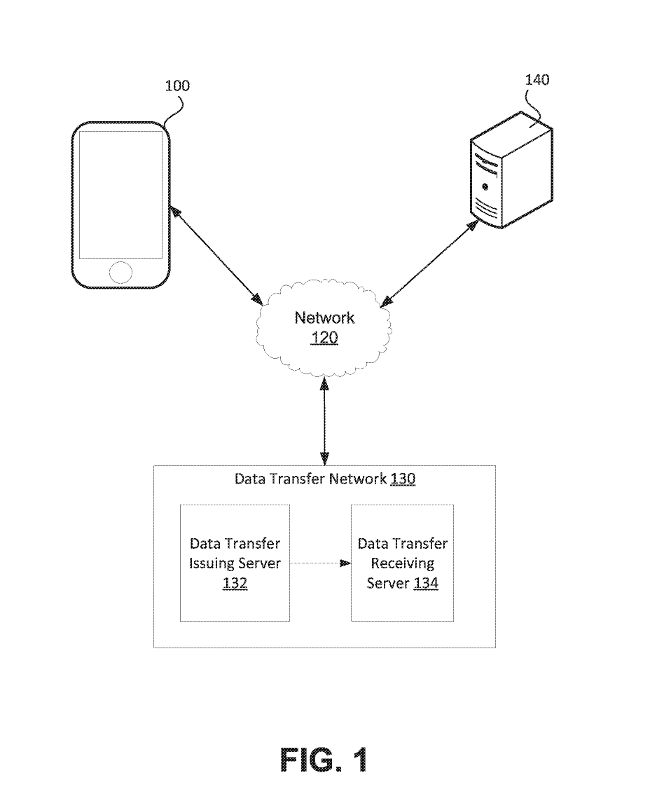

FIG. 1 is a schematic operation diagram illustrating an operating environment of an example embodiment.

The electronic device 100 is a computer system. In some embodiments, the electronic device 100 may be a portable electronic device. For example, the electronic device 100 may, as illustrated, be a smartphone. However, the electronic device 100 may be a computing device of another type such as a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the electronic devices may be associated with one or more users. For instance, a user may operate the electronic device, and may do so to cause the electronic devices to perform one or more operations consistent with the disclosed embodiments. In some embodiments, the electronic device 100 may include a smart card, chip card, integrated circuit card (ICC), and/or other card having an embedded integrated circuit.

The social networking server 140 is a computer system. The server 140 is associated with one or more providers of social media and social networks (e.g. Twitter™, Facebook™, Tumblr™, LinkedIn™, etc.). The server 140 may be, for example, a mainframe computer, a minicomputer, or the like. The server 140 may include one or more computing devices. For example, the server 140 may include multiple computing devices such as database servers, compute servers, and the like. The multiple computing devices may be in communication by a network such as, using the network 120. In another example, the multiple computing devices may communicate using another network such as, for example, a local-area network (LAN). In some embodiments, the server 140 may include multiple computing devices organized in a tiered arrangement. For example, server 140 may include middle-tier and back-end computing devices. In some embodiments, server 140 may be a cluster formed of a plurality of interoperating computing devices.

The server 140 may be configured to maintain one or more social networks having members (e.g. individuals, businesses, etc.) that are linked together through one or more member-established relationships. A provider of the social network associated with server 140 may establish an application programming interface (API) through which the server 140 may receive social media data (e.g. shares, likes, tweets, comments, direct messages, posts, member profile information, etc.) from member devices and through which social media data may be broadcast to member devices, for example, at regular intervals or in response to polling requests (via social media apps) from member devices.

The network 120 is a computer network. The network 120 allows computer systems in communication therewith to communicate. For example, as illustrated, the network 120 may allow the electronic device 100 to communicate with the server 140.

The data transfer network 130 includes a data transfer issuing server 132 and a data transfer receiving server 134. The data transfer network 130 is communicably connected to at least the electronic device 100. Data transfer requests originating from the electronic device 100 are forwarded to the data transfer issuing server 132, and the requested data is transferred, in a suitable format, to the data transfer receiving server 134. In a specific example, where a requested data transfer corresponds to a payment request from the electronic device 100, the data transfer issuing server 132 may be a server operated by a financial institution (i.e. bank) of a user of the electronic device 100. Upon receiving the payment request, the server 132 may authenticate the payment (e.g. based on verifying that there is available credit in the user's bank account) and trigger a corresponding payment transfer to the data transfer receiving server 134. In some embodiments, the server 132 and the server 134 may be the same entity (e.g. server operated by a bank, with the requested payment being transferred between different accounts maintained at the bank).

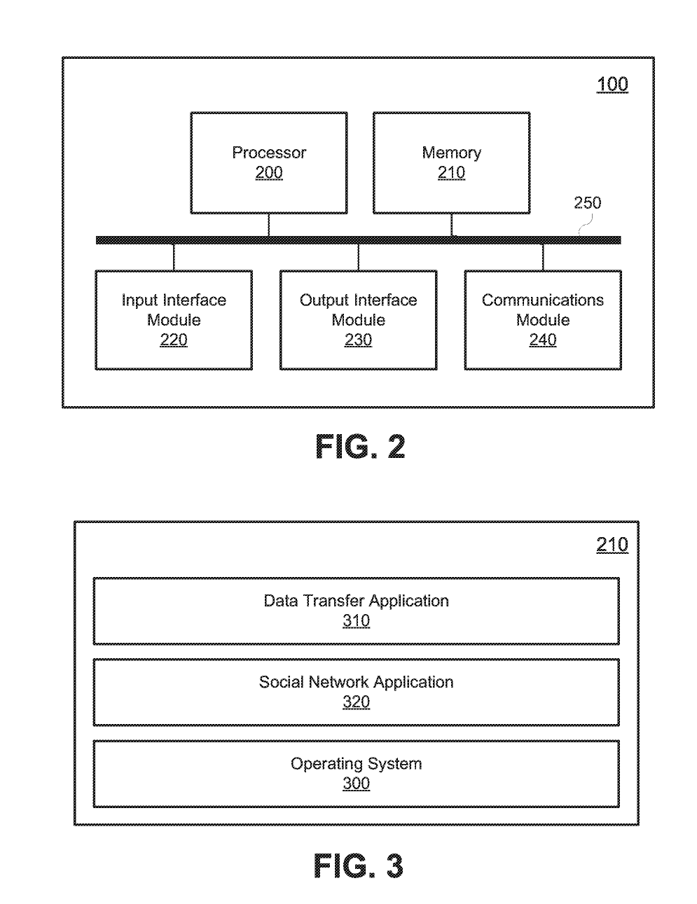

Returning to the electronic device 100, FIG. 2 is a high-level operation diagram of the electronic device 100. As will be discussed in greater detail below, the electronic device 100 includes data transfer application software that allows a user to perform or control data transfers.

The electronic device 100, a computing device, includes a variety of modules. For example, as illustrated, the electronic device 100, may include a processor 200, a memory 210, an input interface module 220, an output interface module 230, and a communications module 240. As illustrated, the foregoing example modules of the electronic device 100 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the electronic device 100.

The input interface module 220 allows the electronic device 100 to receive input signals. Input signals may, for example, correspond to input received from a user. The input interface module 220 may serve to interconnect the electronic device 100 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the electronic device 100 to provide output signals. Some output signals may, for example allow provision of output to a user. The output interface module 230 may serve to interconnect the electronic device 100 with one or more output devices. Output signals may be sent to output devices by output interface module 230. Output devices may include, for example, a display screen such as, for example, a liquid crystal display (LCD), a touchscreen display. Additionally or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the electronic device 100 to communicate with other electronic devices and/or various communications networks. For example, the communications module 240 may allow the electronic device 100 to send or receive communications signals. Communications signals may be sent or received according to one or more protocols or according to one or more standards. For example, the communications module 240 may allow the electronic device 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 240 may allow the electronic device 100 to communicate using near-field communication (NFC), via Wi-Fi™, using Bluetooth™ or via some combination of one or more networks or protocols. For example, where the terminal 110 is a payment terminal such as a POS terminal, the electronic device 100 may communicate via the communications module 240 to effect contactless payments. Contactless payments may be made using NFC. In some embodiments, all or a portion of the communications module 240 may be integrated into a component of the electronic device 100. For example, communications module may be integrated into a communications chipset.

Software including instructions is executed by the processor 200 from a computer-readable medium. For example, software may be loaded into random-access memory from persistent storage of memory 210. Additionally or alternatively, instructions may be executed by the processor 200 directly from read-only memory of memory 210.

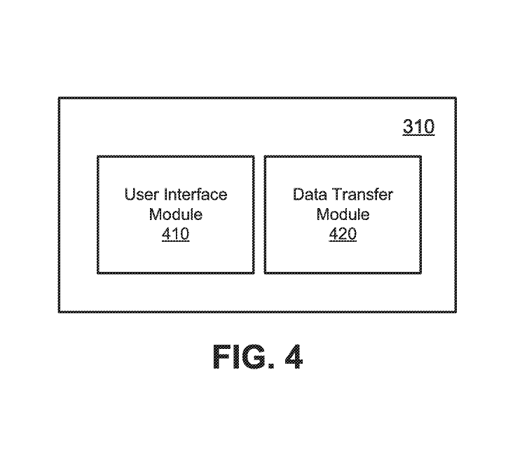

FIG. 3 depicts a simplified organization of software components stored in memory 210 of the electronic device 100. As illustrated these software components include an operating system 300 and a data transfer application 310.

The operating system 300 is software. The operating system 300 allows the data transfer application 310 to access the processor 200, the memory 210, the input interface module 220, the output interface module 230 and the communications module 240. The operating system 300 may be, for example, Apple iOS™, Google™ Android™, Linux™, Microsoft™ Windows™, or the like.

The data transfer application 310 adapts the electronic device 100, in combination with the operating system 300, to operate as a device for performing data transfers according to a variety of supported data transfer methods. The data transfer application 310 may be particular to a particular domain or application. For example, the data transfer application 310 may be a financial application for making data transfers corresponding to financial data. More particularly, the data transfer application 310 may, for example, be a payment application for making data transfers corresponding to particular payment methods. For example, the data transfer application 310 may be a mobile payment application such as when the electronic device 100 is a mobile device.

The data transfer application 310 may include one or more submodules.

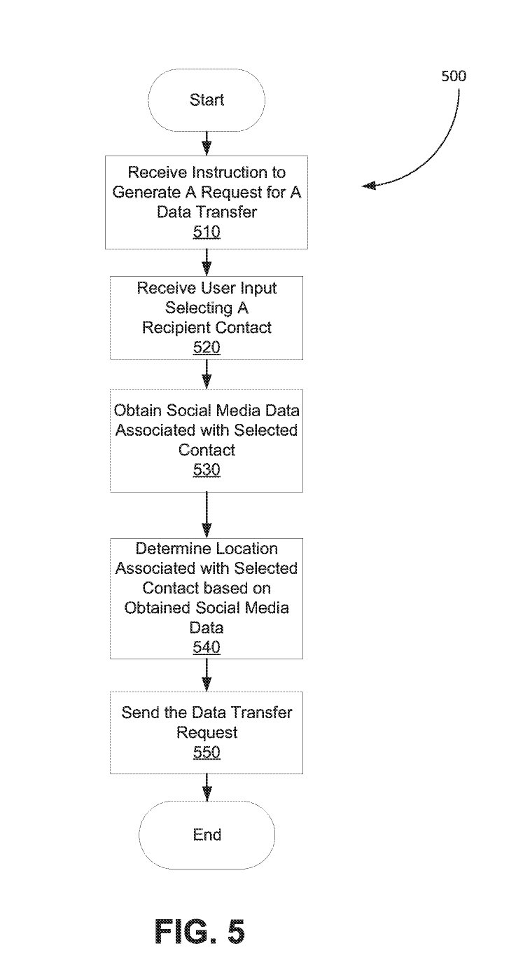

FIG. 4 depicts a simplified organization of submodules exemplary of an embodiment of the data transfer application 310.

As illustrated, the data transfer application 310 includes a user interface module 410 and a data transfer module 420.

The user interface module 410 provides user interface for the data transfer application 310. In some embodiments, the provided user interface may be visual and may include one or more screens or panels allowing a user to configure and control various aspects of the data transfer application 310 and to otherwise review other information related to aspects of the data transfer application 310. For example, a visual user interface may be provided using a display screen accessed via the output interface module 230 (FIG. 2).

The user interface module 410 may process input provided by a user such as may be received, for example, via the input interface module 220 (FIG. 2). For example, a user may provide input for processing by the user interface module 410 using an input device such as, for example, a touch display screen from which input is received. The input from the input device may be received via the input interface module 220.

Additionally or alternatively, the user interface module 410 may provide one or more other forms of user interface such as, for example, an audio-based interface such as may, for example, use text-to-speech or voice recognition to interact with a user.

The data transfer module 420 is responsible for initiating and controlling data transfers performed using the data transfer application 310.

The data transfer module 420 may be configurable to support various different data transfer methods. For example, data transfers may correspond to one or more data types such as, for example, payments. In one example, the data transfer module 420 may support making payments and the various data transfer methods may correspond to different payment methods such as, for example, payments using/from different credit cards, debit cards, bank accounts, or the like. The data transfer module 420 also supports generating requests for payments or remittances, based on automatically determining a type of payment/remittance (e.g. email money transfer, wire transfer, Visa money transfer, etc.). The data transfer module 420 may be configured to automatically populate remittance information requirements in submitting one or more remittance applications.

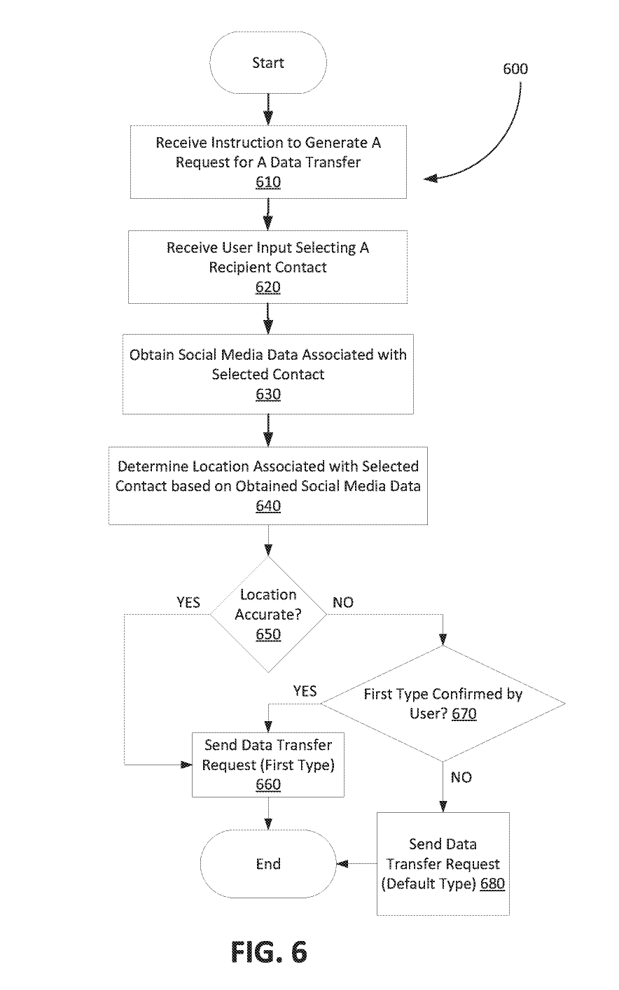

The operation of the data transfer application 310 is described with reference to the flowchart of FIG. 5. Operations 510 and onward of example method 500 are performed by the processor 200 executing the data transfer application 310 at the electronic device 100.

In operation 510, an instruction is received, at the device 100, to generate a request for a data transfer. For example, a user of the device 100 may request, using the data transfer application 310, a data transfer, specifying various information about the requested data transfer including, for example, type of data, quantity of data, scheduled time of transfer, security questions (for authorization of data transfer), etc.

In operation 520, user input selecting a recipient contact for the requested data transfer is received. The contact may by selected by, for example, selection from an address book or one or more social media contacts lists stored on the device 100, or by manual entry via the input interface of the device 100. An address book may, for example, be a comprehensive list of all contacts of a user of the device 100, including those manually saved to the device 100 as well as those that were downloaded to the device 100 by means of synchronization with various applications (e.g. social media apps) installed on the device 100. The recipient contact may also be selected from within a social media application on the device 100. That is, the data transfer application 310 may provide access to a social media application from which a contact or connection may be selected directly. For example, the recipient contact may be selected from a plurality of contacts associated with an account on a first social network, accessible using an associated social media application.

In operation 530, social media data associated with the selected contact is obtained by the device 100. In at least some embodiments, a request may be forwarded to one or more social networking servers, such as server 140 of FIG. 1, querying for data associated with the selected contact. Social media data refers to data that is associated with one or more social networking accounts corresponding to the selected contact and may include, for example, user account information and social media activity for the selected contact on the social networks. A request may be forwarded to social networking servers associated with a subset or all of the social networking accounts corresponding to the selected contact which are accessible on the device 100. The query to a social networking server may indicate specific information that is desired to be retrieved. For example, a suitable query regarding a selected contact may request one or more of the following information: email address, phone number, current and past locations, current and past statuses, check-in places, shared posts/tweets, messages, mutual connections, and comments.

In some embodiments, social media data for recently accessed or frequently used contacts may be stored on the device 100. For example, the metadata for a social media application that was recently used to access the selected contact's profile may, if available on the device, provide some or all of the desired social media data regarding the contact. Accordingly, in operation 530, the social media data may not need to be acquired from a remote location, such as a social networking server; a search of the device data may return the desired information about the selected contact.

In operation 540, a probable location associated with the selected contact is determined based on analyzing the social media data obtained in operation 530. More specifically, a subset of the obtained social media data corresponding to location-related information for the selected contact may be analyzed, to identify a likely current location of the selected contact. Various levels of location granularity may be used to describe the current location of the selected contact, i.e. country, city, town, district, etc. The current location may be determined by considering, among others, content items (e.g. photos, check-ins, tweets, etc.) tagged with location information for the selected contact, such as a last tagged or a commonly tagged location/place, listed place (i.e. country/city) of residence, education, and/or work, date and time stamps of social media content items, locations of friends/connections of selected contact, locations of mutual connections, etc.

In at least some embodiments, the obtained social media data may be filtered to identify those items containing location-related content. Such content items may be identified by, for example, location tags, location-related keywords (e.g. country/city name, place name, etc.) and travel-related keywords that are associated with the items. Once the data is so filtered, the filtered data may, in some embodiments, be ordered chronologically, facilitating the process of determining an approximation of the contact's current location.

In some embodiments, a probable location associated with the selected contact may be determined based on contact information for the contact that is stored on the device 100. For example, if one or more phone numbers for the selected contact is saved on the device 100, area code(s) associated with the phone numbers may inform the likely location(s) of the selected contact.

Once the likely location of the selected contact is determined, in operation 550, the data transfer application 310 sends, to a remote computer, a data transfer request, where the type of the data transfer request is determined based on the location associated with the selected contact. For example, the type of data transfer request may depend on the particular country or city/town that the selected contact is determined likely to be in. In the specific example of payments as data transfers, different types of payment requests may be made according to whether the selected recipient contact is determined to be in the same country (i.e. domestic transfer) or a different country (i.e. international remittance) as the sender of the payment. That is, the probable location of the selected contact with respect to the location of the sender and/or the sender's financial institution may determine the type of the payment request mechanism (e.g. international remittance, email money transfer, credit card money transfer, etc.). The data transfer request may, for example, be sent to a bank server (e.g. for account-to-account money transfers) or to an email server for the recipient contact's email (i.e. email money transfer). In some embodiments, the data transfer request type may be saved in association with a selected contact, for convenience and reference when making future data transfers to the same contact.

Prior to sending the data transfer request, the fields of the data transfer request may be completed on-device or by an independent remittance module located remotely of the device 100. In some embodiments, the processor of the device 100 may populate the data fields of the data transfer request based, at least partially, on the social media data obtained in operation 530 and/or stored contact information for the selected contact. Alternatively, the processor may be configured to transmit, to a remote server, the determined location of the selected contact, a subset of the obtained social media data, and a request to generate a data transfer request based on the determined location of the selected contact and the subset of the obtained social media data. For example, the device 100 may send such requests to a remittance module that is located in a server for a bank of the user of device 100. The remittance module may then generate a first data transfer request based on the location of the selected contact and social media data associated with the selected contact, and send the generated first data transfer to the device 100.

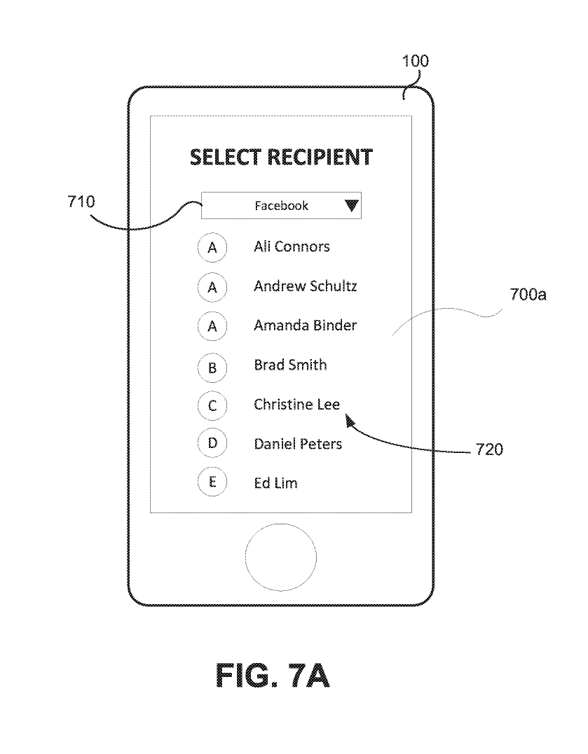

Reference is now made to FIG. 6, which shows another example method 600 for generating a data transfer request. The method 600 is implemented by the processor 200 executing the data transfer application 310 at the electronic device 100.

Operations 610 to 640 correspond to the operations 510 to 540 of method 500 in FIG. 5. In operation 650, the processor determines whether the probable location of the selected contact, identified in operation 640, is sufficiently accurate. The accuracy of the probable location may depend on several factors including, for example, date/time stamps associated with location-tagged content items (i.e. how current is the information from which the probable location is determined) and period and frequency of changes in location (i.e. was the selected contact travelling only and not permanently residing at a particular location). For example, if the period during which the selected contact was deemed to be travelling was the last period of social media activity or update, or if the contact is determined to be a frequent traveller, the probable location determined based on the obtained social media data may not be reflective of the true place of residence for the contact. Similarly, if the last update or activity that is indicative of the selected contact's location is determined to have occurred several years ago, the probable location information for the contact may not be reliable. The accuracy of a determined probable location may be assessed, for example, by assigning numerical weights (or binary values) to the one or more factors that are relevant for ascertaining a true location of a contact and deriving an accuracy value based on said weights.

If, in operation 650, the determined probable location is considered to be accurate (e.g. the derived accuracy value is above a predetermined threshold), the type of the data transfer requested generated by the processor will be based on the probable location of the contact (“first type”). Otherwise, if the probable location is deemed to be inaccurate (e.g. the accuracy value is below the predetermined threshold), the method 600 proceeds to operation 670, in which a user of the device 100 can override the location accuracy determination by manually confirming a type for the data transfer request. Where the probable location of the contact is determined to be accurate or the type (corresponding to the determined probable location) for the data transfer request is confirmed by manual override, a data transfer request of the first type will be sent by the device 100, in operation 660. Otherwise, if the probable location is deemed inaccurate and a user of the device 100 does not provide confirmation of the first type, a data transfer request of a predetermined, default type will be sent, in operation 680.

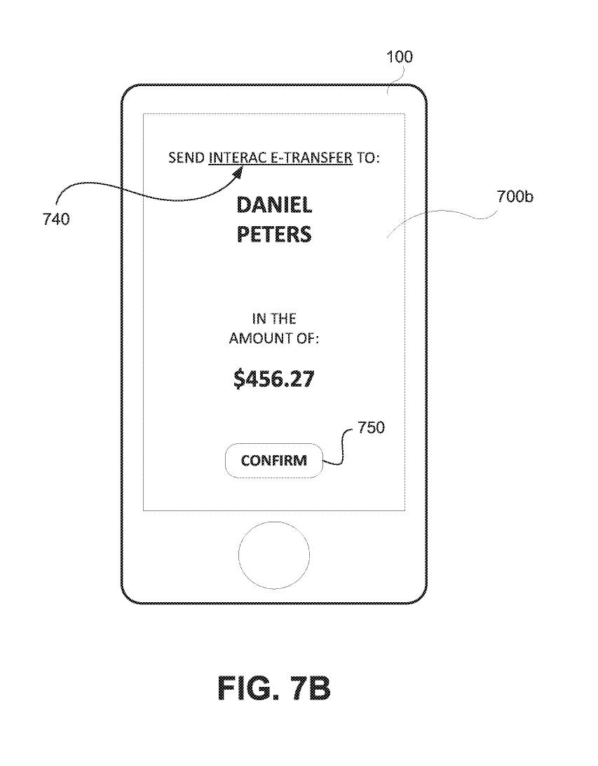

Reference is now made to FIGS. 7A and 7B, which show example user interface screens 700a and 700b for a data transfer application. In screen 700a, a list of possible recipient contacts 720 is displayed. As shown in FIG. 7A, a comprehensive list of contacts on device 100 may be filtered by social network (e.g. “Facebook”) to identify those contacts with whom a connection is established via the social network platform. For example, a user interface element, such as a pull-down menu, may be displayed to facilitate the contact filtering and selection process.

FIG. 7B shows a screen 700b associated with a data transfer request confirmation page. The screen 700b includes an indication 740 of the type of data transfer request that is selected, and a user interface element for providing a confirmation to send the data transfer request for further processing at a remote computer/server, such as a bank server or email server. The screen 700b may also display information about the selected recipient contact (e.g. name, email address, phone number, etc.) and the quantity/amount of data to be transferred to the recipient.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An electronic device, comprising:
an input interface;
a communications module for communicating with one or more computer networks;
a memory; and
a processor coupled to the input interface, the communications module, and the memory, the processor being configured to:
receive, via the input interface:
an instruction to generate a request for a data transfer, and
a selection of a contact for which the data transfer is destined;
obtain social media data associated with the selected contact, the social media data including data associated with one or more social networking accounts corresponding to the selected contact;
determine a location associated with the selected contact based on analyzing location-related information for the selected contact from the obtained social media data; and
send, to a remote computer using the communications module, a data transfer request, wherein a type of the data transfer request is determined based on the location associated with the selected contact.

2. The device of claim 1, wherein the contact is selected from a plurality of contacts associated with an account on a first social network.

3. The device of claim 2, wherein obtaining social media data associated with the selected contact comprises:
sending a request, using the communications module, to a server of the first social network to transmit, to the electronic device, data relating to the selected contact; and
receiving the requested data relating to the selected contact from the server.

4. The device of claim 2, wherein the obtained social media data includes at least one of user account information and social media activity for the selected contact on the first social network.

5. The device of claim 4, wherein the obtained social media data includes one or more content items tagged with location information for the selected contact.

6. The device of claim 1, wherein the memory stores contact information for the selected contact and wherein the location associated with the selected contact is determined based on the stored contact information for the selected contact.

7. The device of claim 1, wherein the processor is further configured to, prior to sending the data transfer request, populate data fields of the data transfer request based on the obtained social media data.

8. The device of claim 1, wherein the processor is further configured to, prior to sending the data transfer request:
transmit, to a remote server, the determined location of the selected contact, a subset of the obtained social media data, and a request to generate a data transfer request based on the determined location of the selected contact and the subset of the obtained social media data; and
receive, from the remote server, a first data transfer request generated based on the determined location of the selected contact and the subset of the obtained social media data.

9. The device of claim 1, wherein the data transfer request is a request to transfer funds to the selected contact.

10. The device of claim 1, wherein obtaining social media data associated with the selected contact comprises collecting data from all social networking accounts corresponding to the selected contact which are accessible on the electronic device.

11. A computer-implemented method, comprising:
receiving, via an input interface of an electronic device:
an instruction to generate a request for a data transfer, and
a selection of a contact for which the data transfer is destined;
obtaining social media data associated with the selected contact, the social media data including data associated with one or more social networking accounts corresponding to the selected contact;
determining a location associated with the selected contact based on analyzing location-related information for the selected contact from the obtained social media data; and
sending, to a remote computer, a data transfer request, wherein a type of the data transfer request is determined based on the location associated with the selected contact.

12. The method of claim 11, wherein the contact is selected from a plurality of contacts associated with an account on a first social network.

13. The method of claim 12, wherein obtaining social media data associated with the selected contact comprises:
sending a request to a server of the first social network to transmit, to the electronic device, data relating to the selected contact; and
receiving the requested data relating to the selected contact from the server.

14. The method of claim 12, wherein the obtained social media data includes at least one of user account information and social media activity for the selected contact on the first social network.

15. The method of claim 14, wherein the obtained social media data includes one or more content items tagged with location information for the selected contact.

16. The method of claim 11, wherein a memory of the electronic device stores contact information for the selected contact and wherein the location associated with the selected contact is determined based on the stored contact information for the selected contact.

17. The method of claim 11, further comprising, prior to sending the data transfer request, populating data fields of the data transfer request based on the obtained social media data.

18. The method of claim 11, further comprising, prior to sending the data transfer request:
transmitting, to a remote server, the determined location of the selected contact, a subset of the obtained social media data, and a request to generate a data transfer request based on the determined location of the selected contact and the subset of the obtained social media data; and
receiving, from the remote server, a first data transfer request generated based on the determined location of the selected contact and the subset of the obtained social media data.

19. The method of claim 11, wherein the data transfer request is a request to transfer funds to the selected contact.

20. A non-transitory computer readable storage medium storing instructions which, when executed by a processor of an electronic device, cause the electronic device to:
receive, via an input interface of the electronic device:
an instruction to generate a request for a data transfer, and
a selection of a contact for which the data transfer is destined;
obtain social media data associated with the selected contact, the social media data including data associated with one or more social networking accounts corresponding to the selected contact;
determine a location associated with the selected contact based on analyzing a subset of the obtained social media data that contains location-related information for the selected contact; and
send, to a remote computer using a communications module of the electronic device, a data transfer request, wherein a format of the data transfer request is determined based on the location associated with the selected contact.
